(19) United States
(12) Patent Application Publication
(10) Pub. No.: US 2010/0169886 A1
(43) Pub. Date: Jul. 1, 2010

(54) DISTRIBUTED MEMORY SYNCHRONIZED PROCESSING ARCHITECTURE

(75) Inventors: Ian Troxel, (US); Paul Murray, (US)

Correspondence Address: MILES & STOCKBRIDGE PC, 1751 PINNACLE DRIVE, SUITE 500, MCLEAN, VA, 22102-3833, US

(73) Assignee: SEAKR Engineering, Incorporated

(21) Appl. No.: 12/347,390

(22) Filed: Dec. 31, 2008

(51) Int. Cl. G06F 9/46

(52) U.S. Cl. 718/101

(57) ABSTRACT

A data processing system comprises a plurality of processors, where each processor is coupled to a respective dedicated memory. The data processing system also comprises a voter module that is disposed between the plurality of processors and one or more peripheral devices such as a network interface, output device, input device, or the like. Each processor provides an I/O transaction to the voter module and the voter module determines whether a majority (or predominate) transaction is present among the I/O transactions received from each of the processors. If a majority transaction is present, the voter module releases the majority transaction to the peripheral. However, if no majority transaction is determined, the system outputs a no majority transaction signal (or raises an exception). Also, a processor error signal (or exception) is output for any processor providing an I/O transaction not corresponding to the majority transaction. The error signal may also optionaly prompt the recovery of any or all processors with methods such as but not limited to reboot/reset based upon predetermined or emergent criteria.

Embodiments of the present invention relate generally to distributed processing and, in particular, to a device, system and method for distributed synchronized processing with distributed memory.

Redundancy is a conventionally used approach for improving the fault tolerance of a processing system. Redundancy can include two or more processors executing the same instructions and processing the same data in parallel. For example, FIG. 2 is a diagram of a typical conventional system in which each of a plurality of processors (202-206) are connected to a central memory (210) and one or more peripheral devices (212) via a voter/comparator circuit (208). Some problems or limitations associated with conventional redundancy designs like that shown in FIG. 2 can include an increase in circuit complexity due to a need to route memory and peripheral lines for each processor through the voter/comparator, and a reduction in system performance or throughput as a result of the voter/comparator analyzing each memory transaction of each processor.

FIG. 3 shows another conventional approach to a redundant or replicated processing architecture (300). In FIG. 3, a system CPU (302) is coupled to system bus agents (304) via a bus. The system bus agents (304) include a memory (306) and one or more peripherals (308). A checker CPU (310) is coupled to the bus. The checker CPU (310) receives transactions passing across the bus and maintains a current processing state relative to the system CPU (302), but does not drive the bus. As the checker CPU (310) processes the bus signals, it compares the outputs of its CPU with those of the system CPU (302). If there is a difference, then the Checker CPU (310) outputs a miscompare signal (312). The miscompare signal (312) can be provided to another processor or system for handling or responding to the miscompare (e.g., instructing the checker CPU (310) to take over processing while the system CPU (302) is reset or rebooted). This design may also be subject to one or more of the problems and limitations discussed above. Another problem or limitation with conventional designs is that the memory may not be sufficiently isolated and limited to interaction with a single processor such that when one of the processors experiences an error, the memory, a peripheral or another processor may be subject to being corrupted by the erroneous processor. Another problem or limitation may be that memory is changed and communications may have occurred before a comparison is performed and a determination of a processor error is made.

In a conventional design where the voter/comparator analyzes each memory transaction, a considerable processing burden may be placed on the comparison or voting decision circuitry. Furthermore, the memory latency of such a conventional design may contribute to a reduction in processor throughput or performance based on the number of replicated processors coupled to the voter circuit. The present invention has been conceived in light of the problems and limitations of conventional designs discussed above, among other things.

One embodiment comprises a data processor that includes an electrically configurable semiconductor device that has been configured to have a plurality of processor cores within the device. Each processor core is directly coupled to its own dedicated and physically-isolated memory. This direct coupling can be achieved, for example, when the processor core includes its own internal memory controller.

The data processor also includes a plurality of peripheral devices and an I/O transaction comparator that is disposed between the processor cores and at least one of the peripheral devices. Each processor core provides an I/O transaction to the I/O transaction comparator and the I/O transaction comparator evaluates the I/O transactions received from the processors to determine whether a predominate (or majority) transaction has been received. The predominate transaction is then released by the I/O transaction comparator to the peripheral device. An exception is raised (or a signal is outputted, for example by setting a bit, flag, register or interrupt) for any processor core not providing an I/O transaction that has been determined to correspond, either exactly or within a predetermined tolerance, to the predominate transaction.

Another embodiment is a data processing system that comprises a plurality of processors, where each processor is coupled to a respective dedicated memory. The data processing system also comprises a voter module that is disposed between the plurality of processors and a peripheral device such as a network interface, output device, input device, or the like. Each processor provides an I/O transaction to the voter module and the voter module determines whether a majority (or predominate) transaction is present among the I/O transactions received from each of the processors.

If a majority transaction is present, the voter module releases the majority transaction to the peripheral. However, if no majority transaction is determined, the system outputs a no majority transaction signal (or raises an exception). Also, a processor error signal (or exception) is output for any processor providing an I/O transaction not corresponding to the majority transaction.

Another embodiment includes a method of operating a distributed memory synchronized processor system. The method includes independently executing software instructions on each of a plurality of processors, where the software instructions (or data) accessed by each processor are read from (or written to) a respective dedicated memory. The method also includes receiving, at a transaction comparator disposed between the plurality of processors and a peripheral, an I/O transaction from each of the processors, and comparing, in the transaction comparator, each of the received I/O transactions to determine whether a majority transaction has been received. If a majority transaction was received, then the transaction comparator releases the majority transaction to the peripheral. However, if a majority transaction was not received, then the method includes outputting an exception indicating that no majority transaction was received. Also, if a minority transaction was received from any processor, the method includes outputting an exception indicating that a minority transaction was received and indicating which processor it was received from.

### BRIEF DESCRIPTION OF THE DRAWINGS

FIG. 1 shows a diagram of an exemplary embodiment of a distributed memory synchronized data processing system;

FIG. 2 shows a diagram of a conventional redundant processor system having a central shared memory and a voter/comparator disposed between the processors and the memory;

FIG. 3 shows a diagram of a conventional redundant processor system having a central shared memory and a system CPU and checker CPU for analyzing transactions between the system CPU and system bus agents;

FIG. 4 shows a diagram of another exemplary embodiment of a distributed memory synchronized data processing system that includes a reference memory;

FIG. 5 a diagram of another exemplary embodiment of a distributed memory synchronized data processing system having a voter/comparator coupled to a group of the peripherals;

FIG. 6 shows a diagram of another exemplary embodiment of a distributed memory synchronized data processing system that includes a single semiconductor device having multiple processor configured therein;

FIGS. 7A-7D show diagrammatic views of an exemplary processor and memory/memory controller configurations; and

FIG. 8 shows a flowchart of an exemplary method of operating a distributed memory synchronized processor system.

### DETAILED DESCRIPTION

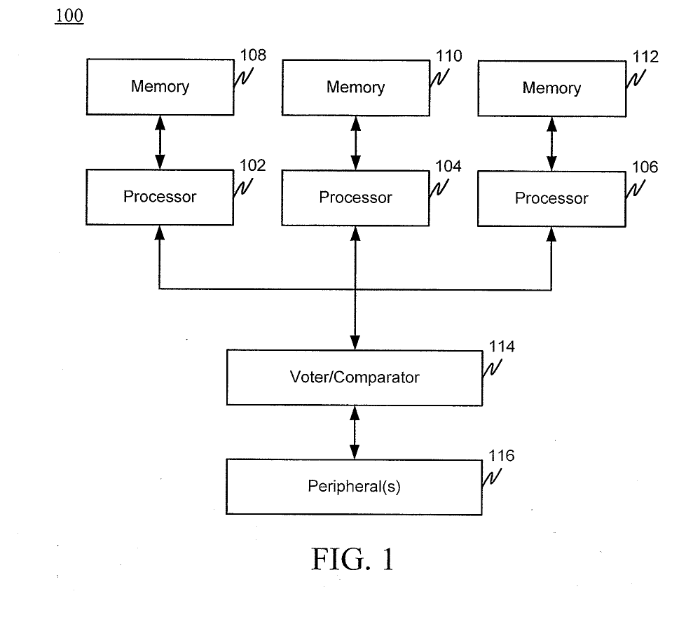

FIG. 1 shows a diagram of an exemplary embodiment of a distributed memory synchronized data processing system 100. In particular, system 100 includes a plurality of processors (102-106) each coupled to a respective dedicated and physically isolated memory (108-112). The system 100 also includes a voter comparator 114 and one or more peripherals 116.

The processors (102-106) can include any digital or analog electrical device or means suitable for data processing or performing calculations, such as microprocessors, microcontrollers, digital signal processors (DSPs), application specific integrated circuits (ASICs), field programmable gate arrays (FPGAs), programmable logic devices (PLDs), or the like. The memories can include read only memory (ROM), random access memory (RAM), dynamic or static memories, volatile or nonvolatile memories, or the like. In particular, the memories can include one or more volatile memory technologies, such as dynamic random access memory (DRAM). DRAM can include double data rate (DDR) RAM including DDR1, DDR2, and DDR3, synchronous dynamic RAM (SDRAM), so-called 1T DRAM that refers to a bit cell design that stores data in a parasitic body capacitor, and/or twin transistor RAM (TTRAM) that is based on the floating body effect inherent in a silicon on insulator (SOI) manufacturing process. The memories can also include static random access memory (SRAM). Also, the memories can also include non-volatile memory technologies, such as flash memory including NAND flash and NOR flash, magnetoresistive random access memory (MRAM), ferroelectric RAM (FeRAM or FRAM), silicon-oxide-nitride-oxide-silicon (SONOS), phase-change memory (also known as PRAM, PCRAM, Chalcogenide RAM and C-RAM), and/or resistive random-access memory (RRAM). The memories can also include read-only memory (ROM), such as programmable read-only memory (PROM) and electrically erasable programmable read-only memory (EEPROM). The memories can be used to store code, data, or both. The components of the system 100 can be coupled by any suitable means such as electrical, optical, radio frequency (e.g., wireless), or the like. The peripherals can include other modules or circuits, input or output devices, a network, a bus, or the like.

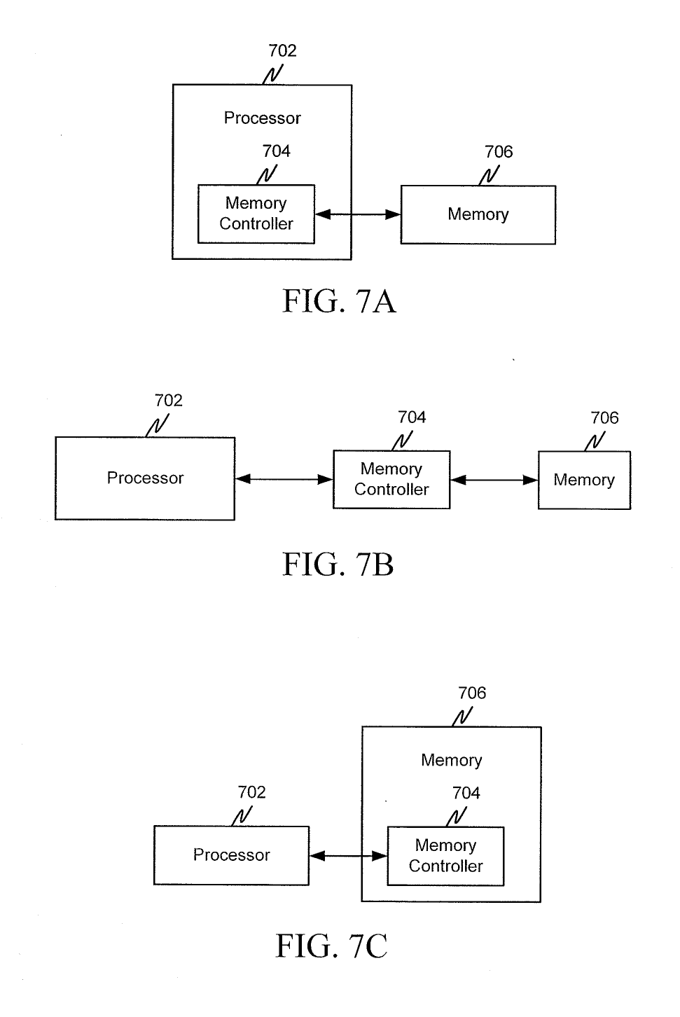

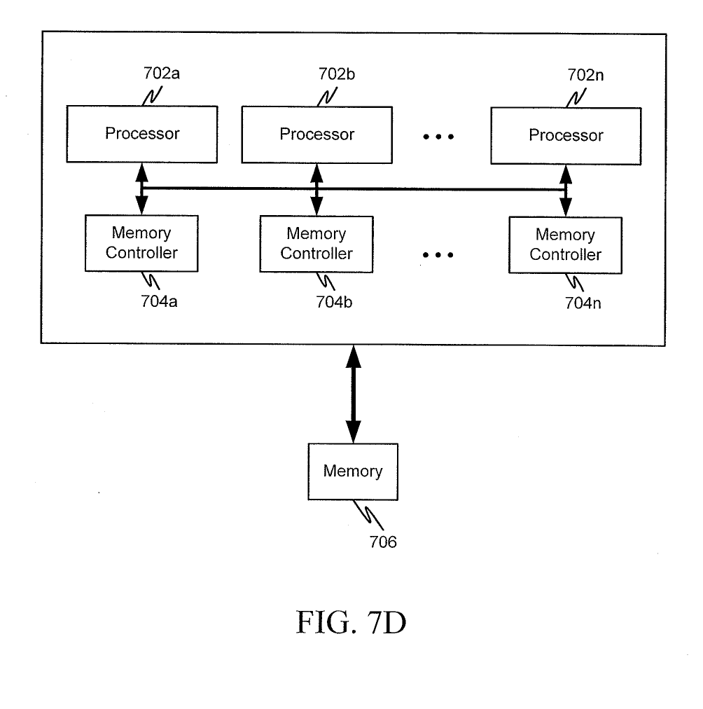

In operation, each of the processors (102-106) accesses its own respective memory (108-112). Each memory is physically isolated and connected only with its respective processor. This can reduce or eliminate the susceptibility of the memory to being corrupted by another processor. Each processor (102-106) executes the same instructions and performs operations on the same input data so that any resulting input/output (I/O) transaction to be output to a peripheral should, in theory, be identical. In addition, the system of FIG. 1 (or of the other embodiments described herein) may include a memory controller that is configured as described below with reference to FIGS. 7A-7D.

The voter/comparator 114 is connected to the processors (102-106) and the peripherals 116 and I/O transactions can be first analyzed by the voter/comparator 114 prior to being released to the peripherals 116. For example in the system 100 of FIG. 1 an I/O transaction is received from each processor (102, 104 and 106). These transactions are compared to determine if a majority transaction is present (e.g., at least two out of the three processors have provided the same (or a corresponding) transaction). Once a majority I/O transaction has been determined, it is then released (or approved for release) by the voter comparator 114 to the peripheral corresponding to the I/O transaction. By analyzing only the I/O transactions, the processors are permitted to operate at full speed with respect to memory transactions. In the system 100 shown, detection of processor errors are effectively time-shifted from a time when the processor encounters a fault or failure to a time when the processor initiates a peripheral transaction that reveals that an internal processor error has occurred. This time-shifting can be an acceptable trade-off in a system where the assumption is that errors will occur infrequently (or be the exception), because the time-shifting of detection yields a system in which the processors can perform at a full throughput rate with respect to memory and a performance reduction only occurs during the typically less-frequent I/O transactions.

In the example of three processors shown in FIG. 1 there are three possible outcomes of the voting/comparison process: (1) all processors provide the same I/O transaction; (2) all processor provide a different and unique I/O transaction; and (3) two processor provide matching I/O transactions, while the third processor provides an I/O transaction that does not match that provided by the other two processors. For case (1) the majority transaction is released or approved for release as described above. For case (3), the majority transaction is handled as described above and, in addition, an exception may be raised (or a signal outputted) to indicate that the processor providing the minority I/O transaction has experienced some type of fault and needs to be reset or rebooted. In case (2), because none of the processors were in agreement (or a majority was not present), an exception may be raised (or a signal outputted) to indicate that a majority I/O transaction was not received and a predefined method to output to peripherals is taken (e.g., output nothing, output an error indication, or the like). A corrective or recovery action may be taken. A recovery action can include one or more of the following: resetting the processor, rebooting the processor, and/or the like.

As an alternative to a majority voting scheme, a predominate transaction scheme can also be used. A predominate transaction is one that is determined to be larger in number (similar to majority voting, but may be a number less than majority), quantity, power, status or importance.

The importance or criticality of a system can be a factor in determining the extent of analyzing I/O transactions and the method by which the I/O transactions are compared. For example, for certain applications it may be desirable that all I/O transactions may be analyzed by the voter/comparator 114. Further, the comparison may need to be an exact bit-wise matching process, such that transactions are consider to correspond only when they are identical down to the bit level. In other applications a less strict comparison scheme may be implemented that can include analyzing a subset of transactions. Also, a less strict scheme may include a comparison that evaluates the values of the I/O transaction data and may accept transactions as matching as long as they are within a predetermined tolerance. In other applications, one or more values within an I/O transaction may be values that are not of concern for comparison purposes (e.g., a “don't care” value) and may differ between I/O transactions that are otherwise determined to match or correspond to each other.

Beyond a majority voting scheme where each I/O transaction is weighted equally in the voting, other schemes can include weighting processors differently. For example, one processor may be designated as the “main” processor and its vote may be weighted more heavily relative to the other processors during the voting/comparison process. The weighting scheme can have multiple levels. Also, the voter/comparator can serve to replicate input going to the processors from the peripherals such that they all receive a given input at the same time (or nearly the same time). Also, a weighting function could be applied to each processor such that the values of one or more processors are either “promoted” or “discredited” relative to each other in the vote. This scheme might be called “correctness prediction” being akin to branch prediction where the past performance is used to guess future performance. This feature may help in the cases when the same processor is often faulty and so the voter may only compare that “discredited” processor's outputs when the other two processors are not in agreement, therefore potentially saving time and resources.

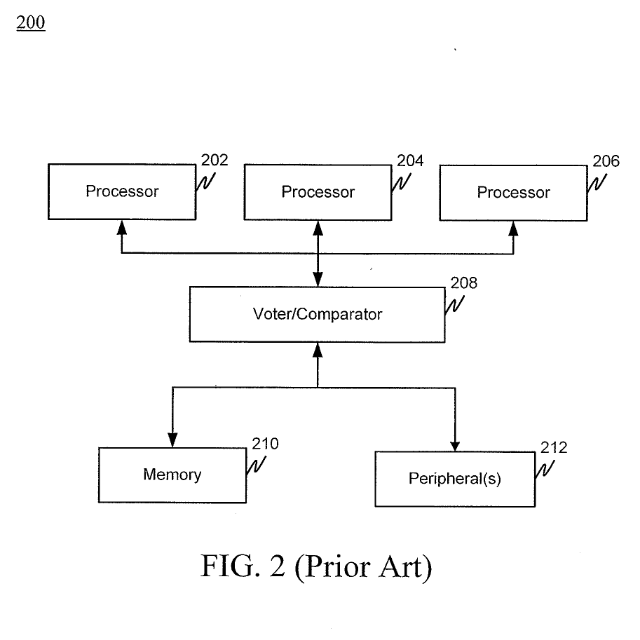

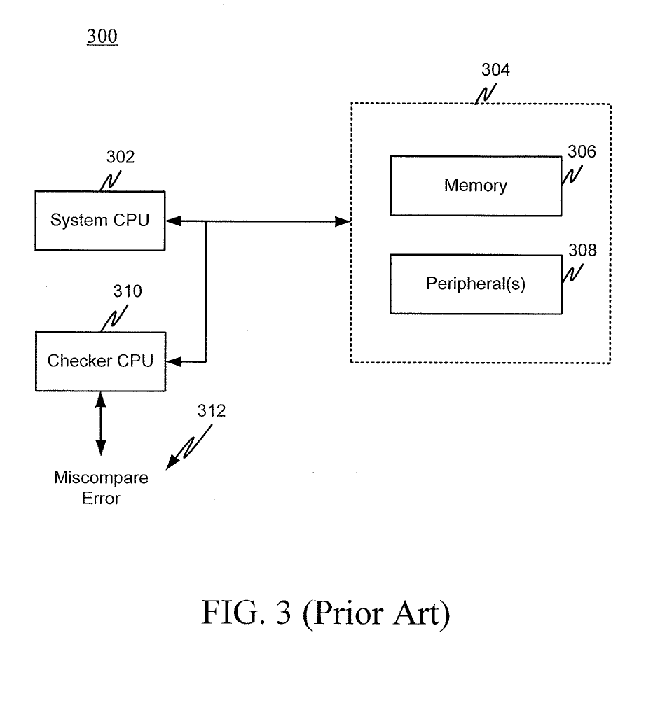

FIG. 2 shows a diagram of a conventional redundant processor system having a central shared memory and a voter/comparator disposed between the processors and the memory, and has been discussed above. FIG. 3 shows a diagram of a conventional redundant processor system having a central shared memory and a voter/comparator for analyzing transactions between the processors and the memory, and has also been discussed above.

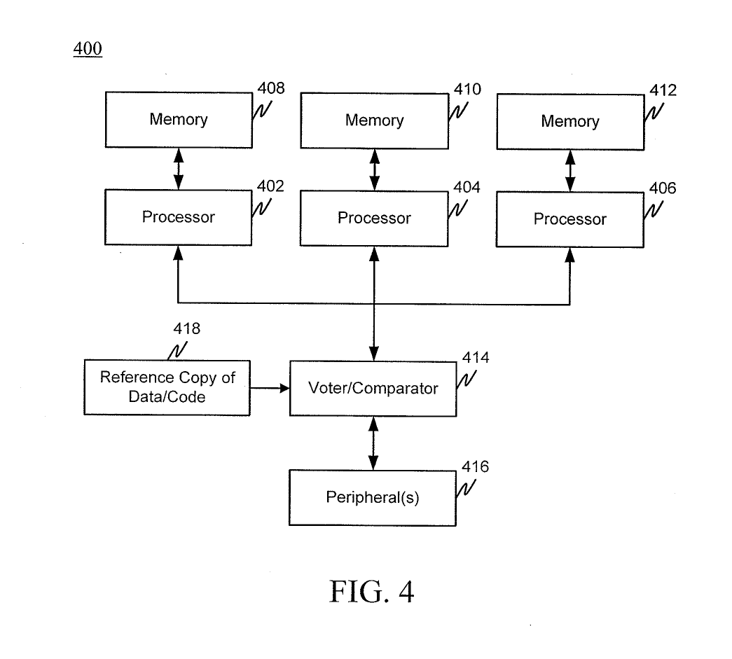

FIG. 4 shows a diagram of another exemplary embodiment of a distributed memory synchronized data processing system 400. In particular, system 400 includes a plurality of processors (402-406) each coupled to a respective dedicated and physically isolated memory (408-412). The system 400 also includes a voter comparator 414 and one or more peripherals 416. The system 400 also includes a reference memory 418 coupled to the voter/comparator 414, and which contains a reference copy of code, data or both.

The system 400 operates substantially as described above with respect to FIG. 1. In situations where one or more processors needs to be rebooted, the code and/or data stored in reference memory 418 (sometimes known as a “golden” or “master” copy) can be used during the rebooting process to restore a processor to a known state. It should be noted that reference memory 418 is physically isolated from the processors (402-406). The reference memory 418 could also be used for comparing results in the voting process such that results computed from an earlier transaction could then be compared to one computed later. Also, the reference memory 418 could be used as part of a built-in self test such that the processors compute a known value that is compared to each other and the reference memory. The result comparison method can be used for authentication at the hardware revel for security purposes (e.g., to verify that a program is not attempting to access a protected region of memory and taking a protective or corrective action if such as access is detected). The reference copy of data/code 418 shown in FIG. 4 is also applicable to other embodiments described herein.

In addition to the uses described above, the reference copy 418 can be used to validate successful reset/restore, to load valid data/instructions such as from a “golden copy”, to perform a built-in self test, to perform a hardware level authentication of the circuit, and/or the like.

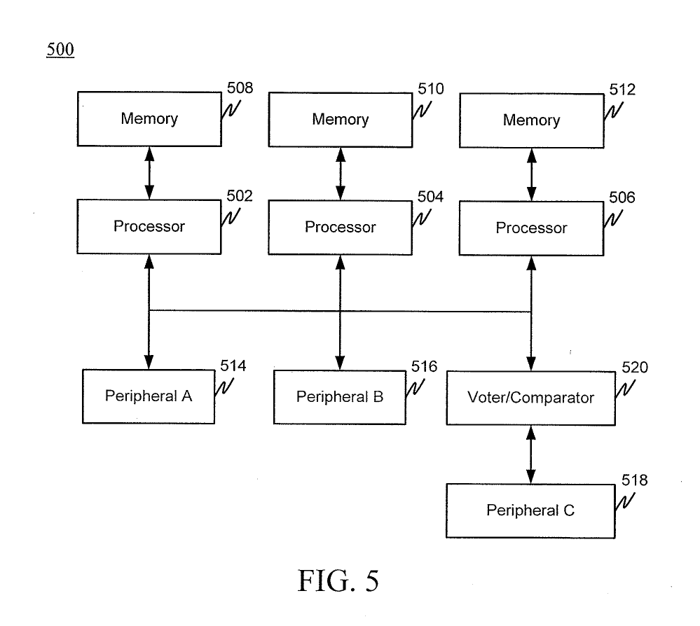

FIG. 5 a diagram of another exemplary embodiment of a distributed memory synchronized data processing system 500. In particular, system 500 includes a plurality of processors (502-506) each coupled to a respective dedicated and physically isolated memory (508-512). The system 500 also includes three peripherals (Peripheral A 514, Peripheral B 516, and Peripheral C 518) and a voter comparator 520 coupled between the processors (502-506) and Peripheral C 518.

In operation, the system 500 operates according to the I/O transaction voting/comparison process described above with respect to FIG. 1 only when processing transactions designated for Peripheral C 518. I/O transactions for Peripherals A and B (514 and 516) are not processed through the voter/comparator 520. The configuration of system 500 may be applicable to systems in which an emphasis is placed on a higher speed and/or frequency of use of subset of the peripherals. Also, an embodiment may not vote on every transaction from processors to a number of peripherals, for example, at certain times the transactions may be voted on, but at other times the system may choose to not vote their transactions. The voter can include a capability for selectively enabling and disabling voting. The enabling/disabling can be selected on a per-peripheral basis. This feature can provide a tradeoff between performance, fault tolerance and power/resource efficiency.

The interconnection between the processors and peripherals can be any suitable means or structure (bus, switched interconnect, mesh, all to all, and/or the like). So, there may be cases when the voter shown in FIG. 5 could be voting transactions for Peripheral B, for example, even though the voter is not directly connected between the processors and Peripheral B.

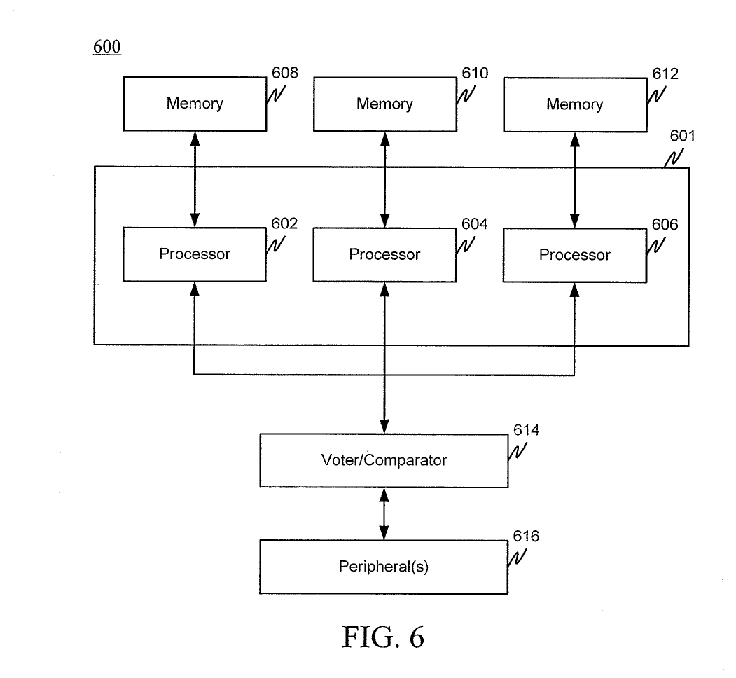

FIG. 6 shows a diagram of another exemplary embodiment of a distributed memory synchronized data processing system 600. In particular, system 600 includes a single semiconductor device 601 having a plurality of processors (602-606) each coupled to a respective memory (608-612). The system 600 also includes a voter comparator 614 and one or more peripherals 616.

The system 600 operates in a similar manner as that described above with respect to FIG. 1. The system 600 differs from the system 100 of FIG. 1 in that the processors (or processor cores) are disposed on a single semiconductor device. This type of device, commonly referred to as a multi-core processor, combines two or more independent cores into a single package typically composed of a single integrated circuit (IC) semiconductor device, called a die. While typically associated with central processing unit (CPU) architecture, multi-core technology is widely used in other technology areas, including embedded processors, such as network processors and DSPs, and in graphics processing units (GPUs). Multi-core can be used to refer to a type of device known as a System-on-a-chip (SoC). Additionally, multi-core can refer to multi-core microprocessors that are manufactured on the same integrated circuit die or to separate microprocessor dies in the same package, also known as a multi-chip module, double core, dual core or even twin core (or quad core, etc.).

In addition to multi-core processors manufactured in hardware, there are multi-core processors that are based on a configuration file (e.g., hardware description language files) loaded onto a configurable logic device. For example, a system or device can include a plurality of soft microprocessor cores placed on a single FPGA. Such “soft cores” are sometimes referred to as “semiconductor intellectual property cores”, but can be considered a CPU core (or other type of core, such as DSP) in the operational sense.

FIG. 7A shows a diagram of an exemplary processor configuration including an onboard memory controller circuit. In particular, processor 702 includes a memory controller 704 that is coupled to a memory 706. The memory controller 704 can be disposed within the processor 702 or may be disposed onboard or on-chip with the processor 702.

FIG. 7B shows a diagram of an exemplary processor configuration including a memory controller circuit disposed between the processor and the memory. In particular, processor 702 is coupled to a memory 706 via an intermediate memory controller 704. It should be appreciated that the memory controller 704 can be disposed external to the processor 702, but still be configured for use as a dedicated memory controller for providing an interface only between the processor 702 and the memory 706, thus becoming, in a sense, an extension of the processor 702.

FIG. 7C shows a diagram of an exemplary processor configuration including a memory having an onboard memory controller circuit. In particular, processor 702 is coupled to a memory 706, which includes a memory controller 704. The memory controller 704 can be disposed within the memory 706 or may be disposed onboard or on-chip with the memory 706.

FIG. 7D shows a diagram of an exemplary multi-core processor configuration including a plurality of processors and a plurality of memory controllers. In particular, processors 702a-702n are coupled to memory controllers 704a-704n, which are coupled to a memory 706. It will be appreciated that there can be one memory controller provided for each processor core, or the number of memory controllers can be more or less than the number of processors. Also, there can be one or more memories coupled to the memory controllers. The memory controllers 704a-704n can each be disposed within a respective processor core or they can be disposed on-chip or on-die with the processor cores.

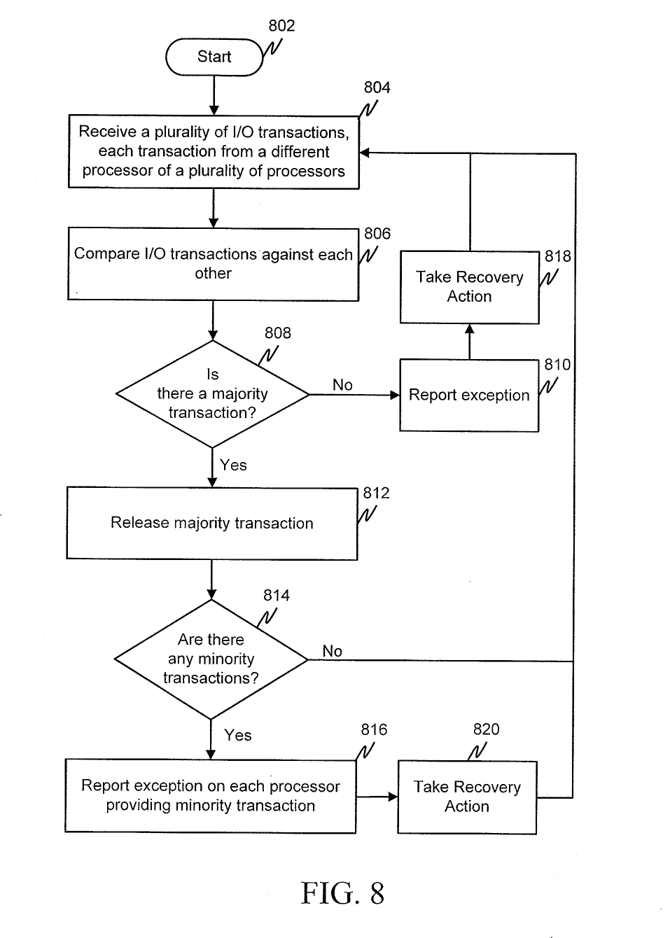

FIG. 8 shows a flowchart of an exemplary method of operating a distributed memory synchronized processor system. In particular, control begins at step 802 and continues to step 804.

In step 804, a plurality of I/O transactions are received. Each transaction is received from a different processor of a plurality of processors. Control continues to step 806.

In step 806, the received I/O transactions are compared against each other and a tally or count is made of those transactions that are determined to correspond or match each other (e.g., each transaction can be considered a “vote”). Control continues to step 808.

In step 808, it is determined whether a majority transaction was received based on the comparison and “vote” counts determined in step 806. If no majority transaction vote count was determined, then control continues to step 810. If a majority count was determined, then control continues to step 812.

In step 810, an exception is raised (or a signal outputted) to indicate that no majority transaction was determined. Control continues to step 818 where a corrective or recovery action occurs (e.g., resetting or rebooting some or all of the processors). Also, a means to handle the output is asserted, with a typical default action being to not output anything in the case when there isn't a majority. However, if a weighting function is used, the output from the processor with the highest “weight” may be used. From this step, control continues back to step 804.

In step 812, the majority transaction is released (or approved for release). Control continues to step 814.

In step 814, the I/O transaction counts are evaluated to determine if any minority transactions were received. In other words, it is determined whether there were any processors that did not provide an I/O transaction that corresponded to or matched the majority transaction. A minority transaction can be an indication that the processor supplying it has experienced a fault or failure. If there were no minority transactions received, then control continues back to step 804. If minority transactions were received, then control continues to step 816.

In step 816, an exception is raised (or a signal provided) corresponding to each processor that provided a minority transaction. Control continues to step 820 where a corrective or recovery action is taken (e.g., resetting or rebooting the processors that were in the minority). From this step, control then continues back to step 804.

While control is shown as continuous in FIG. 8, it should be appreciated that the I/O transaction voting/comparison system may be stopped or started according to a contemplated use of the invention. For example, I/O transaction comparison may be suspended during certain I/O intense operations where full system performance is desirable or required. Further, the exception raised or signal provided may be provided to an internal or external device and may be acted upon internally or externally.

Three processors have been shown and described for purposes of illustrating exemplary aspects and features of the various embodiments. Other embodiments can include a greater number of processors. Two processors may be used, however, there would be no numerical majority absent a weighting or other scheme to “break a tie” between the two processors. The golden code (or reference copy) could be used to break ties in the case of two processors but only if the answer has been pre-computed in a previous run. This option could be used to vote between pairs of processors where two or more voters are in the system each voting outputs from two or more processors and then they exchange the results from their individual votes to perform a second stage voting (where the inputs from other voter(s) is the “golden copy”). This scheme could be used for batch or transaction processing such as in the financial sector.

An embodiment of the present invention can be used to handle situations in which one or more processors encounters a fault. For example, a fault can arise from the interaction of ionizing radiation with the processor(s). Specific examples of ionizing radiation include highly-energetic particles such as protons, ions, and neutrons. A flux of highly-energetic particles can be present in environments including terrestrial and space environments. As used herein, the phrase “space environment” refers to the region beyond about 80 km in altitude above the earth.

Faults can arise from any source in any application environment such as from the interaction of ionizing radiation with one or more of the processors. In particular, faults can arise from the interaction of ionizing radiation with the processor(s) in the space environment. It should be appreciated that ionizing radiation can also arise in other ways, for example, from impurities in solder used in the assembly of electronic components and circuits containing electronic components. These impurities typically cause a very small fraction (e.g., <<1%) of the error rate observed in space radiation environments.

An embodiment can be constructed and adapted for use in a space environment, generally considered as 80 km altitude or greater, and included as part of the electronics system of one or more of the following: a satellite, or spacecraft, a space probe, a space exploration craft or vehicle, an avionics system, a telemetry or data recording system, a communications system, or any other system where distributed memory synchronized processing may be useful. Additionally, the embodiment can be constructed and adapted for use in a manned or unmanned aircraft including avionics, telemetry, communications, navigation systems or a system for use on land or water.

Embodiments of the method, system and apparatus for distributed memory synchronized processing, may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein can be used to implement embodiments of the method, system, or device for distributed memory synchronized processing.

Furthermore, embodiments of the disclosed method, system, and device for distributed memory synchronized processing may be readily implemented, fully or partially, in software using, for example, object or object-oriented software development environments that provide portable source code that can be used on a variety of computer platforms. Alternatively, embodiments of the disclosed method, system, and device for distributed memory synchronized processing can be implemented partially or fully in hardware using, for example, standard logic circuits or a VLSI design. Other hardware or software can be used to implement embodiments depending on the speed and/or efficiency requirements of the systems, the particular function, and/or a particular software or hardware system, microprocessor, or microcomputer system being utilized. Embodiments of the method, system, and device for distributed memory synchronized processing can be implemented in hardware and/or software using any known or later developed systems or structures, devices and/or software by those of ordinary skill in the applicable art from the functional description provided herein and with a general basic knowledge of the computer and electrical arts.

Moreover, embodiments of the disclosed method, system, and device for distributed memory synchronized processing can be implemented in software executed on a programmed general-purpose computer, a special purpose computer, a microprocessor, or the like. Also, the distributed memory synchronized processing method of this invention can be implemented as a program embedded on a personal computer such as a JAVA® or CGI script, as a resource residing on a server or graphics workstation, as a routine embedded in a dedicated processing system, or the like. The method and system can also be implemented by physically incorporating the method for distributed memory synchronized processing in a processing architecture comprising a software and/or hardware system, such as the hardware and/or software systems of a satellite.

It is, therefore, apparent that there is provided in accordance with the present invention, a method, system, and apparatus for distributed memory synchronized processing. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

What is claimed is:

1. A processing system adapted to process data while encountering one or more errors resulting from ionizing radiation, the processing system comprising:
an electrically configurable semiconductor device configured to have one or more processor cores, each processor core being directly coupled to a physically isolated memory;
one or more peripheral devices; and
an I/O transaction comparator disposed between the one or more processor cores and at least one of the peripheral devices,
wherein each processor core provides an I/O transaction to the I/O transaction comparator and the I/O transaction comparator evaluates the I/O transactions to determine a predominate transaction, the predominate transaction being released by the I/O transaction comparator to the at least one peripheral device, and
wherein an exception is raised for any processor core not providing an I/O transaction corresponding to the predominate transaction.

2. The processing system of claim 1, wherein in response to the exception, a recovery action is taken for each processor not providing an I/O transaction corresponding to the predominate transaction.

3. The processing system of claim 1, wherein, if no predominate I/O transaction is determined, an exception indicating no predominate transaction is raised.

4. The processing system of claim 1, wherein the I/O transaction comparator selects the predominate transaction by majority vote.

5. The processing system of claim 1, wherein each of the processors includes a memory controller to control the memory coupled to that processor.

6. The processing system of claim 1, further comprising an additional memory coupled to the I/O transaction comparator, the additional memory to store a reference copy of software instructions and data.

7. The processing system of claim 1, wherein detectability of an error in one or more of the processors is time-shifted from a first time when the error occurs to a second time when an I/O transaction is sent by the one processor to the I/O transaction comparator, the second time being later than the first time.

8. A data processing system comprising:
a plurality of processors, each processor being coupled to a respective dedicated memory; and
a voter module disposed between the plurality of processors and a peripheral, wherein each processor provides an I/O transaction to the voter module and the voter module determines whether a majority transaction is present among the I/O transactions received from the processors,
wherein, if a majority transaction is present, the voter module releases the majority transaction to the peripheral,
wherein, a processor error signal is output for any processor providing an I/O transaction not corresponding to the majority transaction, and
wherein, if no majority transaction is determined, the system outputs a no majority transaction signal.

9. The data processing system of claim 8, wherein each memory is physically isolated from the other memories.

10. The data processing system of claim 8, wherein any processor associated with the processor error signal performs a recovery action in response to the processor error signal.

11. The data processing system of claim 8, wherein all of the processors perform a recovery action in response to the no majority transaction signal.

12. The data processing system of claim 8, further comprising an additional memory coupled to the voter module and isolated from the processors, the additional memory to store a reference copy of data.

13. The data processing system of claim 12, wherein the reference copy of data is used during a processor reset.

14. The data processing system of claim 8, wherein the plurality of processors is collectively disposed in a single semiconductor device.

15. A method of operating a distributed memory synchronized processor system, the method comprising:
independently executing software instructions on each of a plurality of processors, the software instructions being accessed by each processor from a respective dedicated memory;
receiving at a transaction comparator disposed between the plurality of processors and a peripheral, a different I/O transaction from each of the processors;
comparing, in the transaction comparator, each of the received I/O transactions to determine whether a majority transaction has been received;
if a majority transaction was received, releasing, by the transaction comparator, the majority transaction to the peripheral;
if a minority transaction was received from any processor, outputting an exception indicating the minority transaction; and
if a majority transaction was not received, outputting an exception indicating that no majority transaction was received.

16. The method of claim 15, wherein each dedicated memory is physically isolated from the other memories.

17. The method of claim 15, wherein the comparing includes a bit-wise comparison of each received transaction to determine which transactions exactly match one another.

18. The method of claim 15, wherein the majority transaction is determined to be the transaction provided by a majority number of the plurality of processors.

19. The method of claim 15, wherein a recovery action is taken for each processor providing a minority transaction in response to the exception indicating that a minority transaction was received.

20. The method of claim 15, wherein a recovery action is taken for all of the processors in response to the exception indicating that no majority transaction was received.

21. The processing system of claim 1, wherein the ionizing radiation occurs in a space environment.

22. The processing system of claim 1, wherein the processing system is adapted to process data onboard a spacecraft.
